(19) United States
(12) Patent Application Publication
(10) Pub. No.: US 2009/0158855 A1
(43) Pub. Date: Jun. 25, 2009

(54) Aspiration tube vacuum sensor,connector and connector assembly

(76) Inventor: Hugo R. Holden, Minyama, Queensland (AU)

Correspondence Address: JONES DAY, 222 EAST 41ST ST, NEW YORK, NY, 10017, US

(21) Appl. No.: 11/920,136

(22) PCT Filed: May 9, 2006
(86) PCT No.: PCT/AU2006/000604

§ 371 Date: Dec. 12, 2008

(30) Foreign Application Priority Data
May 9, 2005 (AU) 2005902319

(51) Int. Cl. G01L 7/00

(52) U.S. Cl. 73/756

(57) ABSTRACT

The apparatus relates to a membrane based pressure sensor placed on an aspiration tube to determine a more accurate vacuum pump pressure within the aspiration tube, and to the connectors and connector assemblies for use with the pressure sensor.

### FIELD OF THE INVENTION

The invention relates to vacuum sensors and to apparatus for use in medical procedures that involve aspiration of tissues, fluids and the like.

### BACKGROUND OF THE INVENTION

Many medical procedures require the aspiration of tissues and/or fluids. These procedures generally use an apparatus including a pump for generating a negative pressure for providing aspiration. Phacoemulsification and phacoemulsification machines are an example of these procedures and apparatus.

For the purpose of discussing the background to the invention, there now follows a review of phacoemulsification and machines used in this procedure as an example of a type of application to which the invention may be put. It will be understood that the invention may also be applicable to other medical procedures and apparatus that require or provide for aspiration of tissues and/or fluids, especially those procedures wherein tissue architecture is to be retained after aspiration of tissue and/or fluid, such as phacoemulsification.

Phacoemulsification machines are used in eye surgery to remove cataract-affected eye lenses. A typical prior art peristaltic pump-based phacoemulsification machine comprises a probe which includes an irrigation sleeve surrounding a hollow phacoemulsification needle. The needle projects from an end of the irrigation sleeve and is vibrated at ultrasound frequencies by ultrasound crystals which reside inside the probe and which are connected to a driver which is operable to cause the ultrasound crystals to vibrate. The sleeve of the probe is connected to an elevated and inverted bottle of irrigation fluid by an irrigation tube, while the needle is connected to the input port of a peristaltic pump by a length of aspiration tubing.

The peristaltic pump comprises a rotor on which is mounted a plurality of rotatable rollers. A portion of a length of compliant pump tubing which is connected to the aspiration tubing extends partially around the circumference of the rotor and is located between the rotor and an arcuate wall such that the rollers which are in contact with the pump tube pinch the tube between themselves and the arcuate wall. As the rotor rotates about its axis, each of the rollers progress along the length of the arcuate wall so that the pinches in the tubing also progress along the wall. The direction of rotation of the rotor is such that fluid is drawn through the pump tube from the aspiration tube connected thereto and is expelled from an output port of the pump and into a waste collection bag.

The typical prior art peristaltic pump-based phacoemulsification machine also comprises a vacuum sensor for sensing the vacuum which is produced inside the aspiration and pump tubes through the operation of the peristaltic pump.

A vent valve is normally connected to the aspiration tubing near the pump, and is normally operated to connect the interior of the aspiration and pump tubes to atmospheric pressure by venting to a fluid or air source. An example of a suitable fluid source is the output of the pump. The vent valve may be deployed at any time to neutralize any residual vacuum in the aspiration and pump tubes.

The operation of the peristaltic pump is normally controlled by a pedal such that depression of the pedal by the foot of the machine operator (who is usually a surgeon) causes the rotor of the pump to commence rotating at a speed which is proportional to the amount by which the pedal is depressed. The pump will normally commence operating once the pedal has been depressed to a third of its total travel. The pump will normally cease operating once the pedal is released.

The pedal which is used to control the operation of the peristaltic pump is normally also used to, control the vibration of the phacoemulsification needle and the flow of irrigation fluid from the irrigation bottle through the irrigation tube and the sleeve of the probe. When the pedal is initially depressed, a control valve in the irrigation tube is opened so that irrigation fluid is permitted to flow from the bottle through the irrigation tube and from the sleeve. Once the pedal is depressed to two thirds of its total travel, the ultrasound crystals in the probe commence vibrating which causes the needle to vibrate. In addition to stopping the pump as mentioned previously, release of the pedal causes the ultrasound crystals to stop vibrating and closes the irrigation control valve. Releasing the pedal may also deploy the vent valve to vent the aspiration and pump tubes to atmospheric pressure, or a small pump reversal can neutralise any vacuum, stored in the aspiration tube.

In use, the tip of the phacoemulsification needle is inserted into the anterior chamber of a patient's eye by an eye surgeon such that the tip is positioned adjacent the cataract-affected lens of the eye which is to be removed by the phacoemulsification machine to make way for an artificial replacement lens. The surgeon then depresses the pedal of the machine to a third of its total travel so that irrigation fluid flows from the irrigation bottle and into the anterior chamber of the eye from the irrigation sleeve. Further depression of the pedal by the surgeon causes the peristaltic pump to commence operating. Once the surgeon depresses the pedal to two thirds or more, the ultrasound crystals commence vibrating which causes the needle to vibrate at ultrasound frequencies. The vibration of the needle breaks up the natural cataract-affected lens and small particles of the lens are aspirated through the hollow needle and into the aspiration tube as a result of the vacuum produced in the aspiration tube by the operation of the peristaltic pump. The particles then flow through the pump tube from the aspiration tube and into the waste collection bag for disposal. The object of the surgery is to leave the thin outer capsule of the lens behind to form a home for the artificial plastic lens which is inserted into the eye to replace the cataract-affected lens. Irrigation fluid from the irrigation bottle flows into the anterior chamber of the eye from the sleeve of the probe so as to maintain volume and pressure in the chamber and to prevent the chamber from collapsing while the peristaltic pump is operating.

The vacuum sensor of the machine is used to continuously monitor the vacuum inside the aspiration tube at a location therein which is adjacent the input port of the peristaltic pump. If the sensor senses that the vacuum inside the aspiration tube has reached a predetermined maximum allowable level, such as 300 to 500 mmHg vacuum, the peristaltic pump automatically stops operating. Any level from 0 mmHg to 500 mmHg vacuum can be set by the surgeon on the machine. In the peristaltic pump phaco machine, vacuums of 150 to 500 mmHg are usually only generated when the tip of the needle is occluded by particles of the cataract or other tissue. In general, the vacuum would not rise above 150 mmHg without a degree of occlusion, as only modest vacuums of 0 to 100 mmHg are required in the un-occluded state to support the typically used 20 to 60 ml/minute fluid flow rates through the aspiration tube.

A post-occlusion surge will appear in the aspiration tube and eye if, after the vacuum in the aspiration tube has reached the pre-determined maximum level and the peristaltic pump has stopped, the occlusion in the tip of the needle suddenly breaks free. The post-occlusion surge is a result of the pump tube, vacuum sensor, and the aspiration tube, which are normally fabricated from compliant materials, being compressed by atmospheric pressure just prior to the surge occurring so that they store potential energy. When the occlusion breaks free, the pump tube, vacuum sensor, aspiration tube, and other compliant components connected thereto, expand and rapidly draw fluid into the aspiration tube. This causes a sudden rush of fluid from the anterior chamber of the eye into the needle and the aspiration tube. This sudden rush of fluid can cause the anterior chamber of the eye to collapse and cause eye tissue to rush toward the tip of the needle. Eye tissue such as the lens capsule, corneal endothelium (important fragile cells on the inner surface of the cornea), or iris may be engaged by the needle at the time of the surge so that the surge causes significant damage to the tissue. The probability of the post-occlusion surge collapsing the anterior chamber of the eye increases if there is fluid leakage from the anterior chamber around the instruments, probe, and manipulators which are received by the anterior chamber.

The vent valve is used for venting purposes and is generally closed when the pump is operating. The vent valve may be opened to vent the aspiration tube when the pedal is released so that the vacuum in the aspiration tube is neutralized. The vent valve is not deployed in existing phaco machines during a post occlusion surge. This is because the surge peaks around 0.2 seconds after it begins and the vent valve electromechanical delay is too long to be of any use, unless special provisions are made to deploy it.

The peak flow rate of fluid from the eye, and peak pressure loss in the eye during a post-occlusion surge are proportional to the vacuum inside the compliant structures of the phacoemulsification machine just prior to the occlusion in the needle breaking free. The magnitude of the post occlusion surge is also increased by the resistance to fluid flow and the inertia of the fluid in the irrigation pathway. In addition the surge amplitude is influenced by the compliance of the individual's eye. More compliant eyes experience lower amplitude surges, all other things being equal.

Manufacturers of phacoemulsification machines have attempted to reduce the post-occlusion surge by reducing the compliance of the compliant components by using non-compliant aspiration tubing and by improving the flow of irrigation fluid from the sleeve of the probe into the eye.

Before a phacoemulsification machine is used to operate on an eye, the irrigation tube, aspiration tube, and at least parts of the vacuum sensor of the machine must be sterilised or replaced with sterile components. This is because, during surgery, fluid is able to flow between the eye and part of the interior of the vacuum sensor together as well as the lumen of the irrigation and aspiration tubes.

It has become the standard practice of phacoemulsification machine manufacturers to sell kits to the users of their machines which contain lengths of sterilised irrigation and aspiration tubing connected to a sterile single use vacuum sensor cartridge. The vacuum sensor cartridges typically comprise a membrane permanently fixed in a housing with a metal member glued to the membrane so that the membrane can be mechanically attached to a force transducer of the machine without un-sterilising the interior of the irrigation and aspiration tubes or the interior of the vacuum sensor cartridge which communicates with the interior of those tubes. A single kit containing a single vacuum sensor cartridge and lengths of irrigation and aspiration tube connected thereto is relatively expensive and typically costs between seventy and one hundred and twenty Australian dollars. The kits are meant to be disposed of after they are used in an operation as it is not possible to reliably re-sterilise them.

There is a need for new apparatus and components for use in procedures involving aspiration of tissues and fluids, such as phacoemulsification.

### SUMMARY OF THE INVENTION

In one embodiment there is provided an assembly for connection to an aspiration tube to monitor pressure in an aspiration tube, the assembly comprising:

a pressure sensor assembly including a pressure sensor and a coupling device;
a connector for providing pressure communication between an aspiration tube and the coupling device of the pressure sensor assembly; and
a membrane interposed between the pressure sensor assembly and the coupling device which is adapted to flex as a consequence of changes in pressure in the aspiration tube, said flexure being communicated to the pressure sensor via the coupling device, the membrane forming an impermeable barrier between the interior of the aspiration tube and the pressure sensor.

In another embodiment there is provided an apparatus for sensing pressure in an aspiration tube including:
a pressure sensor for sensing pressure;
a connecting member having:
   a first connection arrangement to connect the connecting member to the pressure sensor;
   a second connection arrangement to enable the connecting member to be connected to an aspiration tube coupling;
   a passage extending from an opening in the first connection arrangement to an opening in the second connection arrangement, to bring the sensor into communication with an aspiration tube coupling;
   membrane mounting means formed around the opening in the second connection arrangement;
      wherein the membrane mounting means is configured to locate a membrane against the second connection arrangement when the connecting member is connected to an aspiration tube coupling.

In another embodiment there is provided a connector for connecting an aspiration tube to a pressure sensor to enable the pressure sensor to monitor the pressure in an aspiration tube including:
a connector body having a recess,
a first connection arrangement to enable the connector to be connected to an aspiration tube;
a second connection arrangement to enable the connector to be connected to a pressure sensor;
a flow passage between the recess and the first connector arrangement;
membrane mounting means in or adjacent the recess;
   wherein when mounted to a pressure sensor, a membrane mounted by the mounting means within or adjacent the recess forms an impervious barrier between the flow passage and the pressure sensor and flexure of the membrane within the recess is adapted to communicate pressure variance in the flow passage to the pressure sensor.

### BRIEF DESCRIPTION OF THE DRAWINGS

FIG. 1. A cross section of a disassembled connector assembly according to an embodiment of the invention.

FIG. 2. A cross section of an assembled connector assembly according to an embodiment of the invention showing engagement of membrane mounting means on first and second connecting members with a membrane.

FIG. 3. A cross section of an apparatus according to an embodiment of the invention wherein the membrane mounting means includes a recess on the first end of the first connecting member of the apparatus.

FIG. 4. A cross section of a connector according to an embodiment of the invention showing membrane means located on a second connecting member.

FIG. 5. A 3D view of a connector according to a further embodiment of the invention showing a bayonet style attachment for attachment of the connector to an apparatus according to the invention and a membrane pre-tensioner.

FIG. 6A. A 3D view of a membrane for use with an assembly according to the invention.

FIG. 6B. A 3D view of a membrane according to FIG. 6A, further comprising a pre-tensioner for pre-tensioning the membrane.

FIG. 6C. A 3D view of a membrane having mounting means.

FIG. 6D A 3D view of a membrane according to FIG. 6C, further comprising a pre-tension for pretensioning the membrane.

FIG. 7. A plan view of a membrane according to FIG. 6B.

FIG. 8. A plan view depicting use of the assembly according to the invention in a phacoemulisification machine having a peristaltic pump mechanism.

### DETAILED DESCRIPTION OF THE EMBODIMENTS

In one embodiment there is provided an assembly for connection to an aspiration tube to monitor pressure in an aspiration tube, the assembly comprising:

a pressure sensor assembly including a pressure sensor and a coupling device;
a connector for providing pressure communication between an aspiration tube to the coupling device of the pressure sensor assembly; and
a membrane interposed between the pressure sensor assembly and the coupling device which is adapted to flex as a consequence of changes in pressure in the aspiration tube, said flexure being communicated to the pressure sensor via the coupling device, the membrane forming an impermeable barrier between the interior of the aspiration tube and the pressure sensor.

In one embodiment the coupling device includes a body having a generally planar end face, and a pressure communication passage extending through the body to an inlet in said end face, the membrane forming a seal with said end face around said inlet.

The end face may have an annular membrane sealing formation formed therein which will seal with the membrane, and which will cause said membrane to seat against said end face when the aspiration tube is at atmospheric pressure.

The connector may include a recess and the membrane may be mounted to the connector to form a seal around the recess, with a pressure communication passage extending from the recess through the connector so that, in use, the aspiration tube is in pressure communication with the recess, and changes of pressure in the aspiration tube causes flexure of the membrane.

The membrane may have one or more annular ribs and/or grooves formed therein adapted to engage with one or more corresponding annular formations in the coupling device to ensure proper operative location and/or sealing of the membrane with the coupling device.

The connector may be a single use disposable item having a substantially contaminant free internal passage, and the membrane forms a barrier against the ingress of contaminants into said passage.

In another embodiment there is provided an apparatus for sensing pressure in an aspiration tube including:
a pressure sensor for sensing pressure;
a connecting member having:
   a first connection arrangement to connect the connecting member to the pressure sensor;
   a second connection arrangement to enable the connecting member to be connected to an aspiration tube coupling;
   a passage extending from an opening in the first connection arrangement to an opening in the second connection arrangement, to bring the sensor into communication with an aspiration tube coupling;
   membrane mounting means formed around the opening in the second connection arrangement;
      wherein the membrane mounting means is configured to locate a membrane against the second connection arrangement when the connecting member is connected to an aspiration tube coupling.

The membrane mounting means may be an annular recess that is formed around the opening in the second connection arrangement. The recess may have a generally rectangular cross section. The diameter of the recess may be from 15 to 50 mm, preferably 20 to 25 mm.

The second connection arrangement may include a connection means for detachably connecting the connecting member to an aspiration tube coupling. The connection means may be a screw thread such as a male screw thread.

Alternatively, the connection means may be a lug for engaging with a slot on an aspiration tube coupling.

In some embodiments, the connecting member can be detached from the pressure sensor.

The connecting member may further include a sleeve or cuff for supporting the attachment of the connecting member to the pressure sensor.

In another embodiment there is provided a connector for connecting an aspiration tube to a pressure sensor to enable the pressure sensor to monitor the pressure in an aspiration tube including:
a connector body having a recess,
a first connection arrangement to enable the connector to be connected to an aspiration tube;
a second connection arrangement to enable the connector to be connected to a pressure sensor;
a flow passage between the recess and the first connector arrangement;
membrane mounting means in or adjacent the recess;
   wherein when mounted to a pressure sensor, a membrane mounted by the mounting means within or adjacent the recess forms an impervious barrier between the flow passage and the pressure sensor and flexure of the membrane within the recess is adapted to communicate pressure variance in the flow passage to the pressure sensor.

The membrane mounting means may be an annular rib that is located adjacent the recess. The rib may have a generally triangular cross section.

The second connection arrangement may include connection means for detachably connecting the connector to a pressure sensor. The connection means may be a screw thread, such as a female screw thread.

The connector may further include a membrane being configured to flex in the recess in response to a pressure conditions created therein. The membrane may further include a tensioning means for tensioning the membrane. The membrane may be integrally formed with the connector body.

The membrane may be made from silicone rubber with a hardness over the range of 10 to 60 durometers, with about 10 to 30 durometers hardness preferred. The membrane can also be moulded and contain areas of different thickness which can help give the membrane properties for assisting with sealing.

The connector may further include an aspiration tube attached to the first connection arrangement.

In order that the invention may be more fully understood and put into practice, a various embodiments thereof will now be described with reference to the accompanying illustrations.

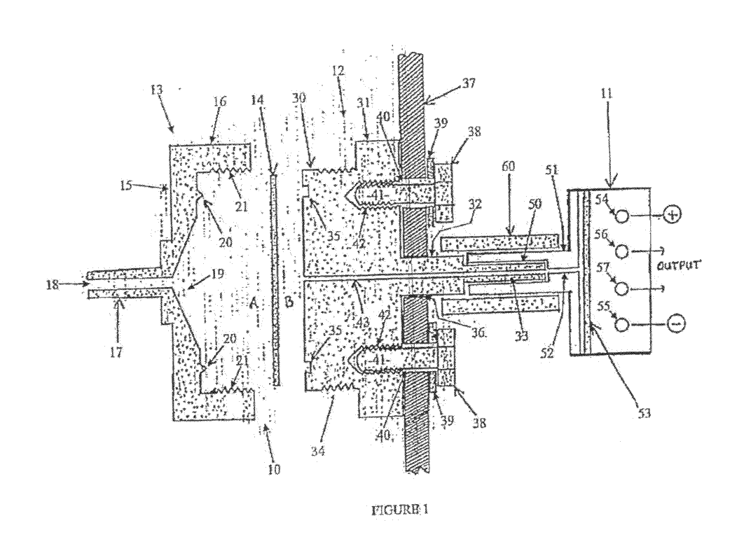

FIG. 1 depicts a connection assembly 10 for connecting an aspiration tube to an input of a vacuum sensor 11 of an apparatus for sensing a vacuum in an aspiration tube. A phacoemulsification machine is an example of such an apparatus.

The connection assembly 10 includes a first connecting member 12, and a second connecting member 13. A membrane, 14, is also depicted although in certain embodiments it will be understood that the assembly may be manufactured and sold without the membrane, the membrane being sold separately.

Second connecting member 13 is depicted as having attachment means being a screw cap that includes an end wall 15 (also referred to herein as a “first end”) and a continuous side wall 16 extending from the perimeter of the end wall 15.

As discussed herein, other forms of attachment means are contemplated, including a bayonet style attachment means that is based on the principle of a lug interlocking with a slot.

A hollow spigot 17 extends perpendicularly from the centre of the end wall 15 in a direction which is opposite to the direction in which the side wall 16 extends from the end wall 15. Spigot 17 includes a passage 18 extending there through, and is designed to be received in the end of an aspiration tube such that the connecting member 13 is thereby connected to the aspiration tube. When the connecting member 13 is connected to the aspiration tube a seal is formed between the aspiration tube and the spigot 17, and air or fluid may flow between the aspiration tube and the connecting member 13 through the passage 18 in the spigot 17. This effectively brings the “recess” or “depression” described herein into communication with pressure in an aspiration tube.

Spigot 17 may alternatively be offset with respect to the axis of the depression also described herein as a “recess” 19. The spigot 17 may then be orientated uppermost to avoid any trapped air in the depression 19. Moreover, there may be more than one spigot 17.

End wall 15 includes a conical-shaped depression 19 and a sealing means in the form of a continuous circular rib 20 which are both concentric with the passage 18. Rib 20 encircles the depression 19 and has a triangular profile which is about 1.2 mm wide at its base. The sides of the rib 20 taper toward each other from the base such that the sides are about perpendicular with respect to each other.

Side wall 16 includes attachment means in the form of a helical thread 21 which extends along an inner surface of the side wall 16 so as to form a female screw thread. Membrane 14 may be an inexpensive and resilient silicone rubber disc having a 1 inch diameter, a thickness of 0.8 mm, and a relatively low mass. The diameter of the membrane 14 is such that the membrane 14 is able to be received by the passage defined by the side wall 16 and is able to cover the rib 20 and the depression 19.

Both the connecting member 13 and the membrane 14 may be reused and may be reliably sterilised using an autoclave. Alternatively the member 13 and membrane 14 may be disposable.

The second connecting member 13 may be detachably secured to the first connecting member 12. As depicted, the first connecting member 12 includes a cylindrical portion 30, a flange portion 31, a projecting portion 32, and a spigot portion 33.

Attachment means are depicted in the form of a helical thread 34 that extends around the circumference of the first end of the first connecting member 12 that is depicted as cylindrical portion 30 so as to form a male screw thread. The diameter of the cylindrical portion 30 is such that the female threaded portion of the second connecting member 13 can be screwed on to the male threaded portion of the cylindrical portion 30 to thereby secure the connecting members 12, 13 together.

Sealing means are depicted in the form of a continuous circular groove 35 that extends along an end of the cylindrical portion 30 of the connecting member 12 and is coaxial with the cylindrical portion 30. Groove 35 may have a constant rectangular profile of about 0.2 mm deep and about 0.8 mm wide. The diameter of the circle formed by the groove 35 is such that when the connecting member 13 is secured to the connecting member 12, the pack of the rib 20 is aligned with the centre of the groove 35 of the complete length of the rib 20 and groove 35.

In use, the projecting portion 32 and the spigot portion 33 of the first connecting member 12 extend through an opening 36 in a panel 37 of the apparatus such that the flange portion 31 rests against an exterior surface of the panel 37. The connecting member 12 is secured to the panel 37 by a plurality of screws 38. Each screw 38 extends through a respective washer 39 and a respective opening 40 in the panel 37. A threaded portion 41 of each screw 38 is screwed into a respective threaded hole 42 which extends into the flange portion 31 of the connecting member 12. The screws 38 are tightened so that the connecting member 12 is firmly secured to the panel 37.

A passage 43 extends through the first connecting member 12 from an opening at the first end 30 such that the passage 43 passes through the cylindrical, flange, projecting, and spigot portions 30 to 33 of the connecting member 12. Passage 43 may have a diameter of about 0.5 mm and may be about 15 to 30 mm long.

In use, the spigot portion 33 of the connecting member 12 is received by a complementary opening 50 in a projecting portion 51 of the vacuum sensor 11. Passage 43 is aligned with a passage 52 which extends through the projecting portion 51. In this depiction, a “chamber” is formed by the connection of passage 43 with passage 52.

Although not forming part of the assembly, the vacuum sensor 11 is a commercially available standard vacuum sensor device that employs a semi-rigid silicon diaphragm 53 operating on a piezo-resistive principle to sense variations of pressure in the passage 52. Terminals 54, 55 are used to connect the sensor 11 to a suitable electrical power supply. Sensor 11 produces a voltage output across output terminals 56, 57 which is proportional to the pressure or vacuum sensed in the passages 52 and 43 by the diaphragm 53. Sensor 11 has a relatively good high frequency response.

A sleeve 60 assists in securing the projecting portion 32 of the connecting member 12 to the projecting portion 51 of the sensor 11. Also, the sleeve 60 assists in forming a seal where the sensor 11 joints the connecting member 12.

Before commencing a medical procedure, the surgeon, theatre nurse, or other appropriate person who is “gloved up” and sterile, ensures that the second connecting member 13 and membrane 14 are sterile and then places the membrane 14 into the passage of the second connecting member 13 which is formed by the side wall 16 such that the depression 19 and rib 20 of the connecting member 13 are covered by the membrane 14. The connecting member 13 is then detachably secured to the connecting member 12 by screwing the threaded portion 21 of the sidewall 16 tightly on to the threaded portion 34 of the cylindrical portion 30 of the connecting member 12. A sterile aspiration tube is then connected to the connecting member 13 such that the spigot 17 is received by an end of the aspiration tube.

Where the apparatus is a phacoemulsification membrane, the other end of the aspiration tube is connected to the probe of the phacoemulsification machine so that fluid is able to flow into the aspiration tube from the needle of the probe. A sterile irrigation tube is also connected to the probe and to an irrigation bottle so that irrigation fluid is able to flow from the sleeve of the probe.

After a procedure is completed, the second connecting member 13 is then unscrewed and removed from the first connecting member 12, and the aspiration and irrigation tubes are disconnected from the probe. The aspiration tube is also disconnected from the connecting member 13, and the irrigation tube is also disconnected from the irrigation bottle. The aspiration and irrigation tubes are then preferably disposed of as it is not possible to reliably re-sterilise them. Both the stainless steel connecting member 13 and the membrane 14 may be sterilised as it is possible to reliably sterilise both components. Alternatively, the membrane 14 may be removed from the connecting member 13 and disposed of as it is relatively inexpensive to replace (i.e. twenty Australian cents), and only the connecting member 13 re-sterilised so that it can be safely reused in another operation.

When the sterile membrane 14 is placed in the sterile second connecting member 13, and the connecting member 13 is secured to the first connecting member 12, the membrane 14 forms a seat between the connecting members 12 and 13 which prevents the un-sterilised connecting member 12 and sensor 11 from contaminating side A of the membrane and the internal portions of the connecting member 13 including the depression 19 and the passage 18 in the spigot 17 which are located on side A of the membrane 14. Once side B of the membrane 14 contacts the un-sterilised connecting member 12, that side of the membrane 14 then becomes un-sterile. Further the sensor is prevented from contamination by fluids and tissues drawn into the aspiration tube. Thus membrane 14 functions as a barrier.

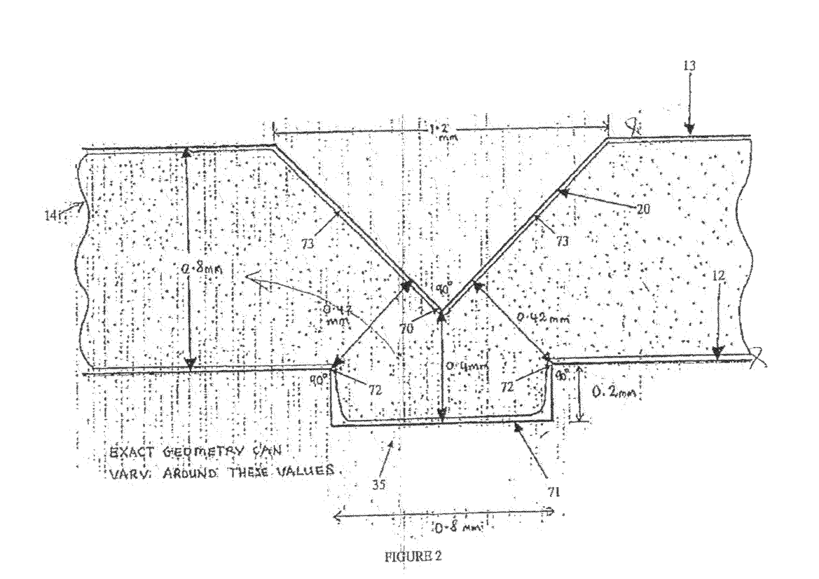

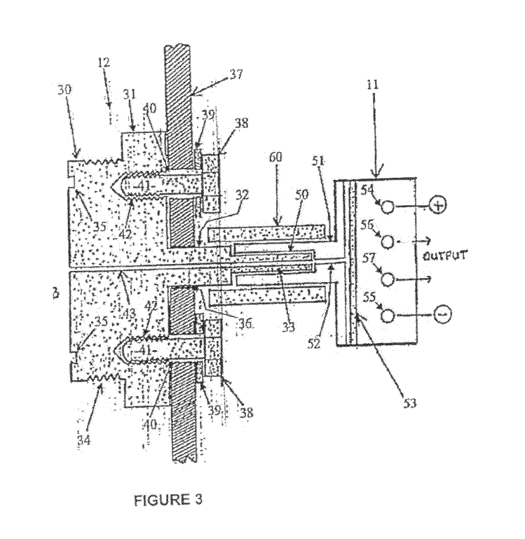

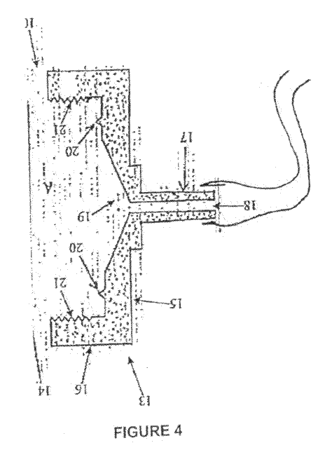

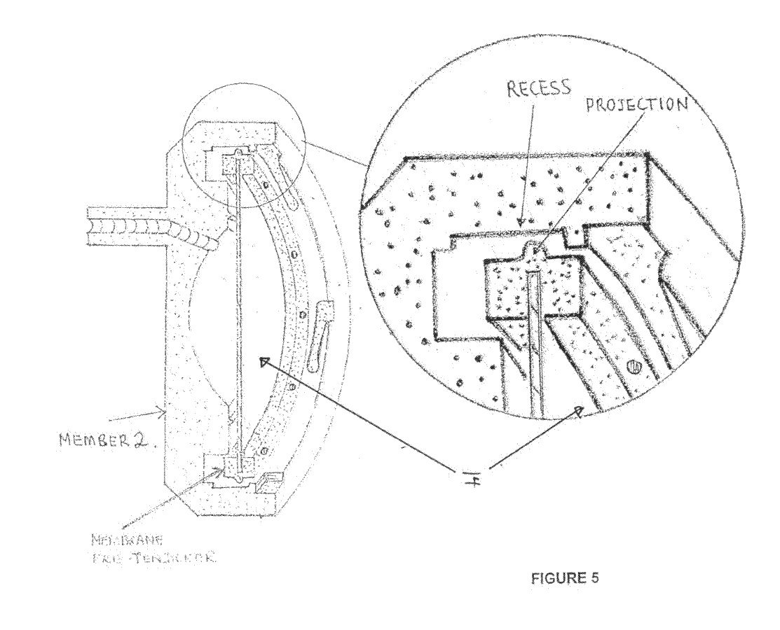

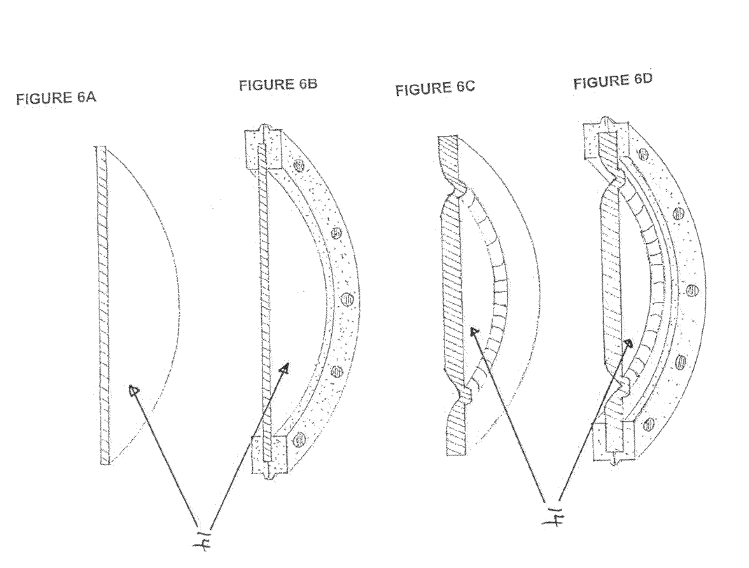

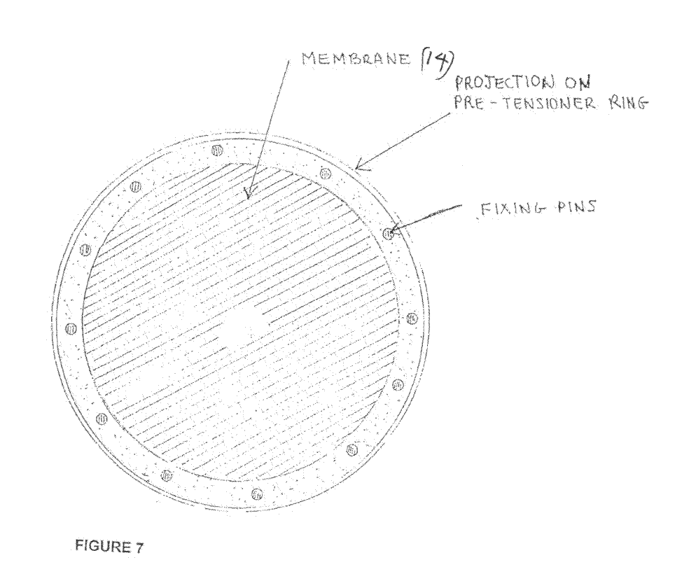

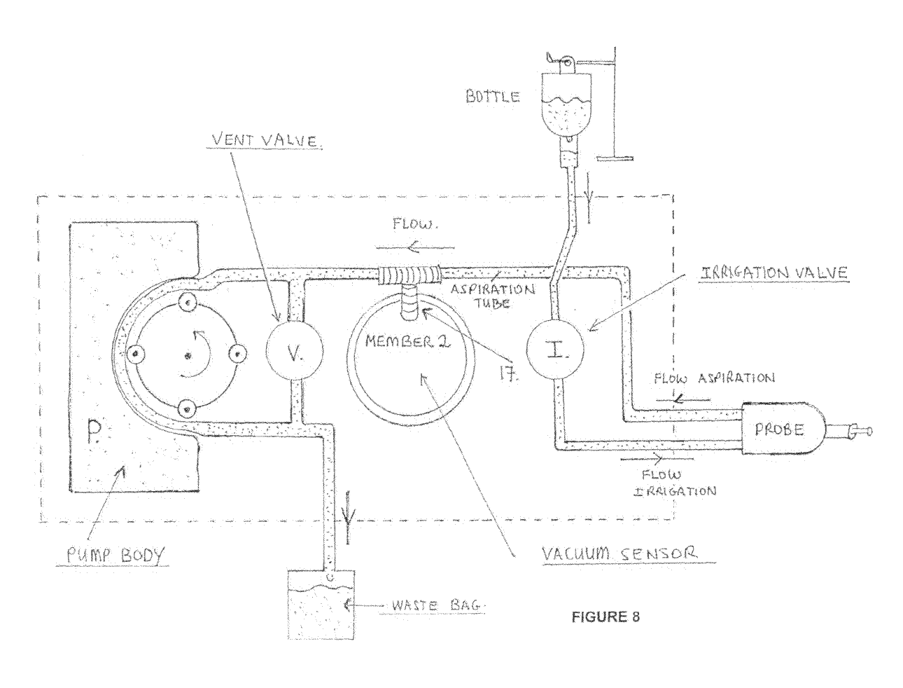

As the vacuum inside the aspiration tube may be very large (e.g. over 500 mmHg) during a phacoemulsification procedure and other procedures involving aspiration of tissues and fluids, there needs to be a “full” vacuum (in some cases reliable to at least one atmosphere or 760 mmHg) between the peripheral portions of the membrane 14 which contact and form a seal with the second connecting member 13 and the first connecting member 12 between passages 18 and 43 in order to ensure that a leak does not form between the membrane 14 and the connecting member 13, or the membrane 14 and the connecting member 12 when there is such a large vacuum in the aspiration tube. The seal formed by the membrane 14 between the connecting members 12, 13 is strong enough to be able to withstand large vacuums in the aspiration tube without a leak forming between the membrane 14 and either of the connecting members 12, 13. In certain embodiment, the seal between the membrane 14 and the connecting members 12, 13 is formed by the tip 70 (see FIG. 2) of the rib 20 (see FIG. 1) compressing the membrane 14 against the flat floor 71 of the groove 35, and by the edges 72 of the groove 35 compressing the membrane 14 against the flat sides 73 of the rib 20 as depicted in FIG. 2. The seal between the membrane 14 and connecting members 12, 13 is able to be formed by hand-tightening the connecting members 12, 13. Completion of the tightening of the connecting members 12, 13 is obvious to feel as the space between the connecting members 12, 13 reaches the thickness of the membrane 14 and the relative rotation, of the connecting members 12, 13 appears to stop abruptly. The tip 70 of the rib 20 is not sharp enough to cut the membrane 14 while the connecting members 12, 13 are being tightened.

The threads on the connecting members 12 and 13 may be replaced if desired with a bayonet style fitting to allow the members 12, 13 to be tightened together by hand in a quarter turn or less. Connecting member 13 and membrane 14 could also be in the form of a single disposable unit if needed.

The geometry of the sealing means 20 and 35 as depicted in an embodiment of the invention shown in FIG. 2 are such that there is negligible displacement of the material of the membrane 14 radially toward the centre of the membrane 14 when the connecting members 12, 13 are tightened together by hand. This is advantageous as otherwise “pseudo vacuum” can be produced when the connecting members 12, 13 are tightened to such an extent that the membrane 14 is radially compressed to cause microscopic bowing of the membrane 14 toward the connecting member 13 and a reduction of pressure in the passage 43 of the connecting member 12. If an excessive pseudo vacuum were present, appropriate electronics or software would be required to offset or zero out the pseudo vacuum. No such electronics or software is required when the connection assembly is used, as the pseudo vacuum is very small.

In order to minimise the compliance of the combination of the connection assembly 10 and sensor 11 so that it does not aggravate post-occlusion surges, the volume of passage 43 is made as small as possible so as to minimise the amount of air which can be held in the passage 43 between the membrane 14 and the vacuum sensor 11. In addition the range of travel of the membrane 14 is kept as small as possible so that a “full” vacuum in the aspiration tube which is connected to the connecting member 13 does not result in the membrane 14 “bottoming out” in the depression 19. Due to the small amount of air which can be stored in the passage 43 and the sensor 11, the compliance of the assembly 10 is kept very low.

In certain embodiments, the presence of the membrane 14 results in the recovered signal from the sensor 11 being attenuated by approximately 5 to 10%. This signal loss can be compensated for by suitably amplifying the signal output by the sensor 11 using an electronic amplifier. The amplified signal can then be processed in the apparatus.

The low mass of the membrane 14 combined with the good high frequency response of the vacuum sensor 11 assist the sensor 11 in responding to very rapid changes in vacuum compared to other sensors which have much more mechanical inertia. This enables an apparatus such as a phacoemulsification machine to detect rapid changes in vacuum.

The sensor 11 in combination with the assembly 10 is able to operate over a broad range of 0 mgHg to 600 mmHg, even though in practice a range of 0 mmHg to 500 mmHg is required. Moreover, the combination of the sensor 11 and assembly 10 has a wide dynamic range as it is able to resolve small changes in vacuum levels such as, for example, from 0 mmHg to 10 mmHg, or 0 mmHg to 500 mmHg. In addition, the assembly 10 and sensor 11 combination has excellent linearity so that the signal which is output by the sensor 11 does not need to be linearised using compensating algorithms or other linearising techniques. The connection assembly 10 and sensor 11 combination is relatively simple and inexpensive so that it can be incorporated into an apparatus such as a phacoemulsification machine at a relatively low cost and can make the machine more affordable to use.

1. An assembly for connection to an aspiration tube to monitor pressure in an aspiration tube, the assembly comprising:
a pressure sensor assembly including a pressure sensor and a coupling device;
a connector for providing pressure communication between an aspiration tube and the coupling device of the pressure sensor assembly; and
a membrane interposed between the pressure sensor assembly and the coupling device which is adapted to flex as a consequence of changes in pressure in the aspiration tube, said flexure being communicated to the pressure sensor via the coupling device, the membrane forming an impermeable barrier between the interior of the aspiration tube and the pressure sensor.

2. An assembly according to claim 1 wherein the coupling device includes a body having a generally planar end face, and a pressure communication passage extending through the body to an inlet in said end face, the membrane forming a seal with said end face around said inlet.

3. An assembly according to claim 2 wherein said end face has an annular membrane sealing formation formed therein which will seal with the membrane, and which will cause said membrane to seat against said end face when the aspiration tube is at atmospheric pressure.

4. An assembly according to claim 1 wherein the connector includes a recess and the membrane is mounted to the connector and forms a seal around the recess, a pressure communication passage extending from the recess through the connector so that, in use, the aspiration tube is in pressure communication with the recess, and changes of pressure in the aspiration tube causes flexure of the membrane.

5. An assembly according to claim 1 wherein the membrane has one or more annular ribs and/or grooves formed therein adapted to engage with one or more corresponding annular formations in said coupling device to ensure proper operative location and/or sealing of the membrane with the coupling device.

6. An assembly according to claim 1 wherein the connector is a single use disposable item having a substantially contaminant free internal passage, and the membrane forms a barrier against the ingress of contaminants into said passage.

7. A connector for use with an assembly according to claim 1.

8. An apparatus for sensing pressure in an aspiration tube including:
a pressure sensor for sensing pressure;
a connecting member having:
a first connection arrangement to connect the connecting member to the pressure sensor;
a second connection arrangement to enable the connecting member to be connected to an aspiration tube coupling;
a passage extending from an opening in the first connection arrangement to an opening in the second connection arrangement, to bring the sensor into communication with an aspiration tube coupling;
membrane mounting means formed around the opening in the second connection arrangement;
wherein the membrane mounting means is configured to locate a membrane against the second connection arrangement when the connecting member is connected to an aspiration tube coupling.

9. An apparatus according to claim 8 wherein the membrane mounting means is an annular recess that is formed around the opening in the second connection arrangement.

10. An apparatus according to claim 9 wherein the recess has a generally rectangular cross section.

11. An apparatus according to claim 8 wherein the second connection arrangement includes connection means for detachably connecting the connecting member to an aspiration tube coupling.

12. An apparatus according to claim 11 wherein the connection means is a screw thread.

13. An apparatus according to claim 12 wherein the screw thread is a male screw thread.

14. An apparatus according to claim 11 wherein the connection means is a lug for engaging with a slot on an aspiration tube coupling.

15. An apparatus according to claim 8 wherein the connecting member can be detached from the pressure sensor.

16. An apparatus according to claim 8, further including a sleeve or cuff for supporting the attachment of the connecting member to the pressure sensor.

17. A connector for connecting an aspiration tube to a pressure sensor to enable the pressure sensor to monitor the pressure in an aspiration tube including:
a connector body having a recess,
a first connection arrangement to enable the connector to be connected to an aspiration tube;
a second connection arrangement to enable the connector to be connected to a pressure sensor;
a flow passage between the recess and the first connector arrangement;
membrane mounting means in or adjacent the recess;
wherein when mounted to a pressure sensor, a membrane mounted by the mounting means within or adjacent the recess forms an impervious barrier between the flow passage and the pressure sensor and flexure of the membrane within the recess is adapted to communicate pressure variance in the flow passage to the pressure sensor.

18. A connector according to claim 17 wherein the membrane mounting means is an annular rib that is located adjacent the recess.

19. A connector according to claim 18 wherein the rib has a generally triangular cross section.

20. A connector according to claim 17, wherein the second connection arrangement includes connection means for detachably connecting the connector to a pressure sensor.

21. A connector according to claim 20 wherein the connection means is a screw thread.

22. A connector according to claim 21 wherein the screw thread is a female screw thread.

23. A connector according to claim 17, further including a membrane being configured to flex in the recess in response to a pressure conditions created therein.

24. A connector according to claim 23, wherein the membrane includes a tensioning means for tensioning the membrane.

25. A connector according to claim 23 wherein the membrane is integrally formed with the connector body.

26. A connector according to claim 17, further including an aspiration tube attached to the first connection arrangement.
